(19) United States
(12) Patent Application Publication
(10) Pub. No.: US 2010/0140037 A1
(43) Pub. Date: Jun. 10, 2010

(54) COUPLING ARRANGEMENT

(75) Inventors: Frank Guenter, Karlsruhe (DE); Goetz Nicklas, Roemerberg (DE)

Correspondence Address: BLISS MCGLYNN, P.C., 2075 WEST BIG BEAVE ROAD, SUITE 600, TROY, MI, 48084, US

(73) Assignee: BorgWarner Inc., Auburn Hills, MI (US)

(21) Appl. No.: 12/595,677

(22) PCT Filed: Apr. 17, 2008
(86) PCT No.: PCT/EP2008/003058

§ 371 Date: Oct. 13, 2009

(30) Foreign Application Priority Data
Apr. 24, 2007 (DE) 10 2007 019 604.2

(51) Int. Cl. F16D 25/10

(52) U.S. Cl. 192/48.603

(57) ABSTRACT

The invention relates to a coupling arrangement comprising a component (6) fixed to a housing, a piston (2) that is located rotatably about an axis of rotation (ω) relative to the component (6) fixed to a housing, a rotatable component (1) designed as a component mounted rotatably about the axis of rotation (ω) relative to the component fixed to a housing and having a chamber (8) in the front region of the piston (2), a line arrangement (4) forming a communication line through the component (6) fixed to a housing and the rotatable component (1) to the chamber (8) for a pressure medium, and a rotary feedthrough seal (3) sealing the line arrangement (4) between the component (6) fixed to a housing and the rotatable component (1), wherein a radial inner distance (ri) and/or a radial outer distance (ra) of the piston (2) from the axis of rotation (ω) is less than a radial seal distance (r0) of the rotary feedthrough seal (3).

### CROSS-REFERENCE TO RELATED APPLICATIONS

This application claims benefit of PCT Patent Application PCT/EP2008/003058 entitled “COUPLING ARRANGEMENT” and filed on Apr. 17, 2008, which claims benefit of German Patent Application 10 2007 019 604.2 filed on Apr. 24, 2007.

### BACKGROUND OF INVENTION

1. Field of Invention

The invention relates to a clutch arrangement.

2. Description of Related Art

Single and multiple clutch arrangements having a housing-fixed component, having one or more hollow cylindrical pistons which are arranged so as to be rotatable about a rotational axis relative to the housing-fixed component, and having a rotatable component or component which can be set in rotation which is formed, relative to the housing-fixed component, as a component which is arranged around the rotational axis, which rotatable component or component which can be set in rotation has a hollow cylindrical chamber, or in the case of a plurality of pistons a plurality of hollow cylindrical chambers, at the end side of the piston(s), are generally known. Furthermore, the clutch arrangement has at least one line arrangement which, for a pressure medium in the form of hydraulic oil, forms a communication line through the housing-fixed component and through the rotatable component to the chamber. A rotary leadthrough seal serves to seal off the line arrangement between the housing-fixed component and the rotatable component.

A disadvantage of such arrangements is that, with increasing rotational speed of the rotatable component in the chambers, greater centrifugal forces act on the hydraulic oil present in the chambers. A centrifugal-force-dependent or rotational-speed-dependent pressure is generated in the chambers. If the pressure becomes too high, this can lead to an undesired closure of the clutch. To compensate this, provision is made of devices or controllers for centrifugal force compensation. A disadvantage, therefore, in particular in hydraulically directly actuated clutches, is a centrifugal force pressure which builds up in the rotating pressure piston and which, in the case of normally open clutches, can lead to an automatic closure of the clutch as a function of rotational speed, and therefore centrifugal force compensating pistons must be used.

It is the object of the invention to propose a clutch arrangement which makes centrifugal force compensation superfluous, or necessary only to a reduced extent.

### SUMMARY OF INVENTION

The present invention overcomes the disadvantages in the related art in a clutch arrangement that has a housing-fixed component. A piston is arranged so as to be rotatable about a rotational axis relative to the housing-fixed component. A rotatable component, relative to the housing-fixed component, is arranged around the rotational axis and has a chamber in an end-side region of the piston. A line arrangement, for a pressure medium, forms a communication line through the housing-fixed component and rotatable component to the chamber. Proceeding from the rotational axis, a radial inside distance and/or a radial outside distance of the piston is smaller than a radial seal distance of a rotary leadthrough seal.

In particular, a rotary leadthrough seal seals off the line arrangement between the housing-fixed component and the rotatable component. Particularly preferable here is an arrangement in which, proceeding from the rotational axis, a radial outside distance of the piston is smaller than a radial seal distance of the rotary leadthrough seal.

A ratio [(r0-ri)/(ra-r0)] of firstly the radial inside distance ri of the piston and of secondly the radial outside distance ra of the piston to the radial seal distance r0 is preferably dimensioned such that, at a predetermined rotational speed of the rotatable component, a pressure acting on the piston does not actuate the piston. The predetermined rotational speed preferably corresponds to a predefined rated rotational speed, in particular a maximum rotational speed, of a drive, which is assigned to the other components, during operation.

The rotatable component preferably has a piston seal or forms a piston seal. The line arrangement advantageously forms a communication line also to at least one further chamber for a further piston, wherein it is preferably also the case that, proceeding from the rotational axis, a radial inside distance of the further piston, too, is smaller than the radial seal distance of the rotary leadthrough seal.

Provision may be made of an additional device and/or controller for centrifugal force compensation which permits centrifugal force compensation in particular in only an upper rotational speed range of the rotatable component. This makes it possible for the device and/or controller for centrifugal force compensation for only high rotational speed ranges of the drive to be of smaller dimensions.

Other objects, features, and advantages of the present invention will be readily appreciated as the same becomes better understood while reading the subsequent description taken in conjunction with the accompanying drawings.

### BRIEF DESCRIPTION OF EACH FIGURE OF DRAWING

An exemplary embodiment of the present invention is explained in more detail below on the basis of the drawing. Identical reference symbols used in the various figures of the drawing denote identical or equivalent components and/or functions and are preferably explained in more detail only on the basis of one of the figures. In the drawing:

FIG. 1 schematically shows an arrangement principle of components of a clutch and a diagram illustrating pressure conditions in a chamber of the clutch;

FIG. 2 shows a sectional view through an exemplary dual clutch for implementing the functional principle from FIG. 1; and

FIG. 3 shows a further exemplary clutch arrangement.

### DETAILED DESCRIPTION OF INVENTION

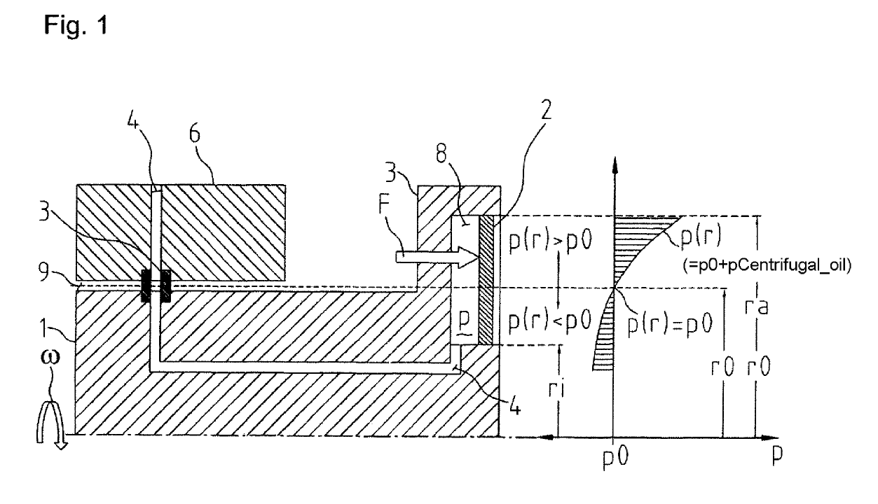

As is schematically shown in FIG. 1, a clutch arrangement for forming a single clutch or multiple clutch has a housing-fixed component 6. Arranged within the housing-fixed component 6 is a rotatable component 1 which may if appropriate also be of multi-part design and which can be set in rotation about a rotational axis ω by means of a drive device such as a motor. For the actuation of the clutch, the clutch arrangement has at least one cylinder-piston arrangement with a piston 2 which is of annular or substantially hollow cylindrical design at least at the end side, with the piston 2 being arranged so as to be rotatable about the rotational axis ω relative to the housing-fixed component 6. The piston 2 is in particular of cylindrical design. For the actuation of the piston 2, the rotatable component 1 has an annular or hollow cylindrical chamber 8 which faces toward the end side of the piston 2 and which holds the piston 2. The rotatable component 1 is therefore formed as a component which is arranged, relative to the housing-fixed component 6, around the rotational axis ω, which rotatable component 1 has a chamber 8 in the end-side region of the piston 2. As shown in the diagram, the rotatable component 1 may be formed as a piston seal or have a piston seal.

For the actuation of the piston 2, that is to say for the exertion of a force F on the end side of the piston 2, a line arrangement leads to the chamber 8 in order to conduct a pressure medium, usually hydraulic oil, into or out of the chamber 8. Since a pump for pumping the pressure medium is expediently arranged in a housing-fixed manner relative to the housing-fixed component but the chamber 8 is formed within the rotatable component 1, a first section of the line arrangement 4 leads through the housing-fixed component 6 and a second section of the line arrangement 4 leads through the rotatable component 1 to the chamber 8. In this way, the line arrangement forms a communication line for the pressure medium, which communication line leads through both the housing-fixed component 6 and also the rotatable component 1.

One or two rotary leadthrough seals 3 are arranged in the transition region between the housing-fixed component 6 and the rotatable component 1, which rotary leadthrough seals 3 seal off the line arrangement 4 with respect to a gap 9 between the housing-fixed component 6 and the rotatable component 1. Continuous pressurization of the second, rotatable section of the line arrangement 4 is possible by virtue of an encircling groove being formed in the housing-fixed component 6 and/or in the rotatable component 1 in the transition region to the housing-fixed component 6, such that the line arrangement 4 forms an open communication line for the pressure medium preferably in every rotational position of the rotatable component 1.

To eliminate or reduce the requirement for centrifugal force compensation, the components are dimensioned in an advantageous manner in the radial direction proceeding from the rotational axis ω. As can be seen from FIG. 1, proceeding from the rotational axis ω, a radial inside distance ri of the piston 2 is smaller than a radial seal distance r0 of the rotary leadthrough seal 3. This has the effect, during a rotation, that a vacuum is generated relative to the radial seal distance if) in that section of the chamber 8 which faces toward the rotational axis ω.

In the illustrated embodiment, proceeding from the rotational axis ω, a radial outside distance ra of the piston 2 is advantageously greater than the radial seal distance r0 of the rotary leadthrough seal 3. This has the effect that, in the conventional way, an overpressure is generated relative to the radial seal distance r0 in the outer section of the chamber 8 during a rotation. In special embodiments, proceeding from the rotational axis ω, the radial outside distance ra of the piston 2 may however also be smaller than the radial seal distance r0 of the rotary leadthrough seal 3.

It is therefore advantageously possible, by means of a suitable selection of the radial inside distance ri of the piston 2, of the radial outside distance ra of the piston 2 and of the radial seal distance r0 of the rotary leadthrough seal 3, to predefine a rotational-speed-dependent pressure p in the chamber 8. The dimensioning is carried out such that, for a typical predetermined rotational speed, centrifugal force compensation is preferably not required, or is required only to a reduced extent, at the predetermined rotational speed. For this purpose, the ratio [(r0-ri)/(ra-r0)] of firstly the radial inside distance ri of the piston 2 and of secondly the radial outside distance ra of the piston 2 to the radial seal distance r0 for the predetermined rotational speed of the rotatable component is dimensioned such that a force F acting on the piston 2, or an overall pressure p acting in the chamber 8, does not actuate the piston 2 even without additional centrifugal force compensation. This means that the force acting on the overall piston surface is, in total, zero.

In addition to the advantageous possibility of defining a typical and common rotational speed as the predetermined rotational speed, it is also possible for a maximum rotational speed of the drive to be used as the predetermined rotational speed. In the event of pressure compensation being provided below the maximum rotational speed, provision is preferably made of a device and/or controller for centrifugal force compensation as an additional element in the conventional way, with such a device and/or controller for centrifugal force compensation being dimensioned so as to activate centrifugal force compensation in only a predetermined upper rotational speed range of the rotatable component 1. In this way, it is possible to provide a centrifugal force compensation arrangement which is of smaller dimensions and which is activated only in an optional manner, with centrifugal force compensation being activated at the maximum rotational speed, which is encountered only rarely.

As is also shown by means of the diagram in FIG. 1, a pressure p=p(r), which is dependent on diameter and on rotational speed, is generated in the chamber 8 during a rotation of the rotatable component 1. In the regions between the radial inside distance ri of the piston 2 and the radial seal distance r0, the pressure p(r)<p0 is lower than the pressure p(r0)=p0 which is generated at the radial seal distance r0. In regions between the radial seal distance r0 and the radial outside distance ra of the piston 2, the pressure p(r)>p0 is increased in relation to the pressure p(r0)=p0 generated at the level of the radial seal distance r0. The resultant force F which acts on the end side of the piston 2 can be calculated by integration of the pressure p(r) across the region from the radial inside distance ri to the radial outside distance ra of the piston 2.

It is therefore possible to utilize the fact that a centrifugal-force-dependent pressure component p_{centrifugal}_{_{—}}ₒᵢₗ in the outer section of the chamber 8 can be compensated by means of a corresponding vacuum in the inner section of the chamber 8. The essence of the concept is therefore a suitable diameter selection which considerably reduces the overall centrifugal-force-dependent pressure, thereby permitting structural designs with reduced centrifugal force compensation or even no centrifugal force compensation. By means of suitable gradation of the diameters of the piston seals relative to the diameters of the rotary leadthrough seals, or of the radial inside distance and radial outside distance of the piston relative to the radius of the rotary leadthrough seals, the centrifugal oil pressure can be entirely or partially compensated even without using a counteracting compensation piston.

If a value of smaller than the radial seal distance r0, and therefore smaller than the radius of the rotary leadthrough seals, is selected for the radial inside distance of the piston, then during a rotation, a vacuum is generated in that region of the chamber 8 which is at a radial distance from the rotational axis of less than the seal distance r0. Furthermore, the radial outside distance ra of the piston is preferably selected such that, in the outer region of the chamber 8, a centrifugal oil pressure is generated which, in interaction with the described vacuum, is suitable for forming overall pressure conditions within the chamber 8 which correspond to ambient pressure or the desired actuating pressure.

If a value of smaller than the radial seal distance r0, and therefore smaller than the radius of the rotary leadthrough seals, is selected for the radial inside distance of the piston, then during a rotation, a vacuum is generated in that region of the chamber 8 which is at a radial distance from the rotational axis of less than the seal distance r0. Furthermore, the radial outside distance ra of the piston is preferably selected such that, in the outer region of the chamber 8, a centrifugal oil pressure is generated which, in interaction with the described vacuum, is suitable for forming overall pressure conditions within the chamber 8 which correspond to ambient pressure or the desired actuating pressure.

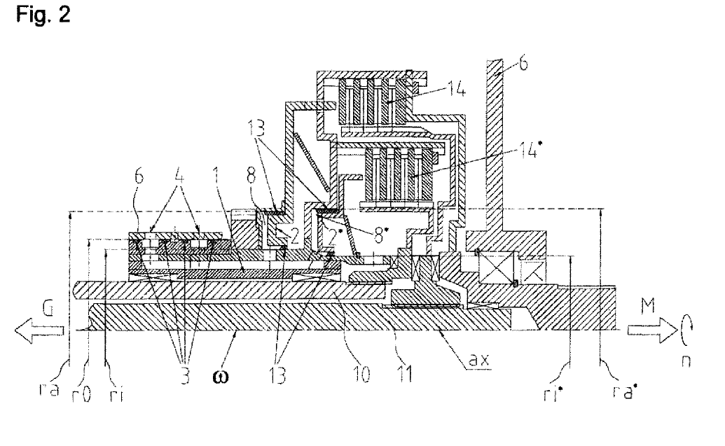

FIG. 2 shows a first exemplary embodiment on the basis of a dual clutch, illustrating the components and functional elements which have been described on the basis of FIG. 1. Here, identical reference symbols denote the components described on the basis of FIG. 1, such that only differences will be described. Further rotatable components 10, 11, in this case transmission input shafts of a dual-clutch transmission, are arranged within the rotatable component 1 which is designed as a piston seal. In addition to a chamber 8 for holding a first piston 2, the rotatable component 1 has a second chamber 8* for holding a second piston 2*. Corresponding further components of a multiple clutch can be actuated in the usual way by means of the two pistons 2, 2*. The illustrated embodiment shows an arrangement in which a separate line of the line arrangement 4 leads to each of the chambers 8, 8*.

As in the embodiment depicted in FIG. 1, it is also the case in the embodiment depicted in FIG. 2 that the dimensioning of the radial distances to the rotational axis ω is selected such that the radial inside distances ri, ri* of the two pistons 2, 2* are again smaller than the radial seal distance r0 of the rotary leadthrough seal 3. In the case of different radial inside distances ri, ri* of the two pistons 2, 2*, a separate line arrangement 4 is preferably provided, for setting the resultant forces in the chambers 8, 8*, for each of the chambers 8, 8* in order to be able to predetermine the pressure conditions individually. In this exemplary embodiment, the radial outside distances ra, ra* of the two pistons 2, 2* are each selected to be greater than the radial seal distance r0.

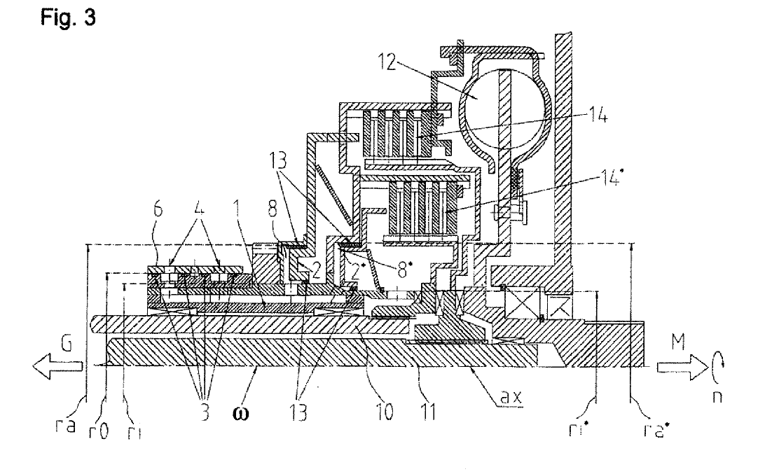

FIG. 3 shows a further exemplary embodiment of a dual-clutch device, in contrast to the embodiment in FIG. 2, having an integrated torsional vibration damper 12. As in FIG. 2, additional pistons seals 13 are illustrated. The two pistons 2, 2* actuate in each case one associated clutch 14, 14*.

It has been found that a clutch arrangement according to the invention can be activated more effectively and more precisely on account of the elimination, or at least reduction, of centrifugal-force-dependent pressure components.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

1. A clutch arrangement comprising:
a housing-fixed component (6);
a piston (2) that is arranged so as to be rotatable about a rotational axis (ω) relative to said housing-fixed component (6);
a rotatable component (1) that is, relative to said housing-fixed component (6), arranged around said rotational axis (ω) and has a chamber (8) in an end-side region of said piston (2); and
a line arrangement (4) that, for a pressure medium, forms a communication line through said housing-fixed component (6) and rotatable component (1) to said chamber (8), wherein, proceeding from said rotational axis (ω), at least one of a radial inside distance (ri) and a radial outside distance (ra, ra*) of said piston (2) is smaller than a radial seal distance (r0) of a rotary leadthrough seal (3).

2. The clutch arrangement as set forth in claim 1, wherein a ratio [(r0-ri)/(ra-r0)] of said radial inside distance (ri) and radial outside distance (ra) of the piston (2) to said radial seal distance (r0) at a predetermined rotational speed of said rotatable component (1) is dimensioned such that a pressure (p) acting on said piston (2) does not actuate said piston (2).

3. The clutch arrangement as set forth in claim 2, wherein said predetermined rotational speed corresponds to a predefined rated rotational speed of an associated drive.

4. The clutch arrangement as set forth in claim 1, wherein said rotatable component (1) has a piston seal.

5. The clutch arrangement as set forth in claim 1, wherein said line arrangement (4) forms an additional communication line to at least one further chamber (8*) for a further piston (2*) and, proceeding from said rotational axis (ω), a radial inside distance (ri*) of said further piston (2*) is smaller than said radial seal distance (r0) of said rotary leadthrough seal (3).

6. The clutch arrangement as set forth in claim 1, wherein a controller for centrifugal force compensation is arranged so as to provide centrifugal force compensation in an upper rotational speed range of said rotatable component (1).

7. The clutch arrangement as set forth in claim 1, wherein said piston (2) is of substantially hollow and cylindrical at least at said end-side region and said chamber (8) is substantially hollow and cylindrical.

8. The clutch arrangement as set forth in claim 4, wherein said piston seal is attached to said piston.

9. The clutch arrangement as set forth in claim 1, wherein said line arrangement (4) forms an additional communication line to at least one further chamber (8*) for a further piston (2*) and, proceeding from said rotational axis (ω), said radial outside distance (ra) of said further piston (2*) is smaller than said radial seal distance (r0) of said rotary leadthrough seal (3).
